(19) United States
(12) Patent Application Publication
(10) Pub. No.: US 2015/0153837 A1
(43) Pub. Date: Jun. 4, 2015

(54) METHOD AND APPARATUS FOR LOGGING IN AN APPLICATION

(71) Applicant: TENCENT TECHNOLOGY (SHENZHEN) COMPANY LIMITED, Shenzhen (CN)

(72) Inventor: Jian LIU, Shenzhen (CN)

(21) Appl. No.: 14/616,560

(22) Filed: Feb. 6, 2015

Related U.S. Application Data
(63) Continuation of application No. PCT/CN2013/080693, filed on Aug. 2, 2013.

(30) Foreign Application Priority Data
Aug. 9, 2012 (CN) 201210282434.6

(51) Int. Cl. G06F 3/01; G06F 21/62; G06K 9/00; G06F 21/36

(52) U.S. Cl. CPC G06F 3/017; G06F 21/36; G06F 21/629; G06K 9/00355

(57) ABSTRACT

According to an example, a user device obtains a gesture track of a user and queries a gesture track database according to the gesture track obtained, wherein the gesture track database stores a relationship between the gesture track and account information of the user. The user device obtains the account information corresponding to the gesture track and provides the account information to a log-in server, so as to log in the application.

### CROSS REFERENCE TO RELATED APPLICATIONS

This application is a continuation application of International Patent Application No. PCT/CN2013/080693, filed on Aug. 2, 2013, which claims the benefit of Chinese Patent Application No. 201210282434.6, filed on Aug. 9, 2012, the disclosures of both of said applications being herein incorporated by reference in their entirety.

### FIELD

The present disclosure relates to computer techniques, and more particularly, to a method and an apparatus for logging in an application.

### BACKGROUND

With the developments of computers, more and more applications may be installed in computers. In order to log in an application, a user needs to input account information, i.e., a user name and a password. Due to the openness of the applications, most applications allow switching of accounts, i.e., for one application, a user may have multiple sets of names and passwords. When desiring to switch an account, the user inputs a new account he wants to use. This process requires frequent inputs and the operation is complex. In addition, the keyboard input may leak the account of the user. The more times that the account is inputted, the higher the risk becomes.

### SUMMARY

According to an example of the present disclosure, a computer-implemented method for logging in an application is provided. The method includes:

obtaining, by a user device, a gesture track of a user;

querying, by the user device, a gesture track database according to the gesture track obtained, wherein the gesture track database stores a relationship between the gesture track and account information of the user;

obtaining, by the user device, the account information corresponding to the gesture track; and

providing, by the user device, the account information to a log-in server, so as to log in the application.

According to another example of the present disclosure, an apparatus for logging in an application is provided. The apparatus includes:

a first gesture track obtaining module, configured to obtain a gesture track of a user;

a querying module, configured to query a gesture track database according to the gesture track obtained by the gesture track obtaining module, and to obtain account information corresponding to the gesture track if the gesture track database contains the gesture track;

a log-in module, configured to provide the account information obtained by the querying module to a log-in server, so as to log in the application; and

the gesture track database, configured to save a relationship between the gesture track and the account information.

According to still another example of the present disclosure, a non-transitory computer-readable storage medium comprising a set of instructions for logging in an application is provided, the set of instructions to direct at least one processor to perform acts of:

obtaining, by a user device, a gesture track of a user;

querying, by the user device, a gesture track database according to the gesture track obtained, wherein the gesture track database stores a relationship between the gesture track and account information of the user;

obtaining, by the user device, the account information corresponding to the gesture track; and

providing, by the user device, the account information to a log-in server, so as to log in the application.

Other aspects or embodiments of the present disclosure can be understood by those skilled in the art in light of the description, the claims, and the drawings of the present disclosure.

### BRIEF DESCRIPTION OF THE DRAWINGS

Features of the present disclosure are illustrated by way of example and not limited in the following figures, in which like numerals indicate like elements, in which:

FIG. 1 is a schematic diagram illustrating an example of a user device for executing the method of the present disclosure.

FIG. 2 is a schematic diagram illustrating a method for establishing a relationship between gesture track and account information according to an example of the present disclosure.

FIG. 3 is a flowchart illustrating a first method for obtaining the gesture track of the user according to an example of the present disclosure.

FIG. 4 is a flowchart illustrating a second method for obtaining a gesture track of the user according to an example of the present disclosure.

FIG. 5(a) and FIG. 5(b) are schematic diagrams showing two gesture tracks according to an example of the present disclosure.

FIG. 6 is a flowchart illustrating a method for logging in an application according to an example of the present disclosure.

FIG. 7 is a schematic diagram illustrating an apparatus 70 for logging in an application according to an example of the present disclosure.

FIG. 8 is a schematic diagram illustrating a structure of the gesture track obtaining module 701 according to an example of the present disclosure.

FIG. 9 is a schematic diagram illustrating a structure of the gesture track obtaining module 701 according to another example of the present disclosure.

FIG. 10 is a schematic diagram illustrating an apparatus for logging in an application according to an example of the present disclosure.

### DETAILED DESCRIPTION

The preset disclosure will be described in further detail hereinafter with reference to accompanying drawings and examples to make the technical solution and merits therein clearer.

For simplicity and illustrative purposes, the present disclosure is described by referring to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the term “includes” means includes but not limited to, the term “including” means including but not limited to. The term “based on” means based at least in part on. In addition, the terms “a” and “an” are intended to denote at least one of a particular element.

In various examples of the present disclosure, when the user desires to log in an application or switch an account of the application, a gesture track of the user is obtained. A gesture track database which saves a relationship between the gesture track and account information of the user is queried to obtain the account information corresponding to the gesture track. Then, the user device may transmit the account information obtained to a log-in server for authentication. If the authentication succeeds, the user successfully logs in the application. According to various examples of the present disclosure, the user is only required to input the gesture track when desiring to log in the application or switch the account of the application. Compared with conventional systems, the user does not need to input the user name and the password directly. Since the direct input of the account information is avoided, the account information has a lower risk to be stolen and the user's operation is simplified.

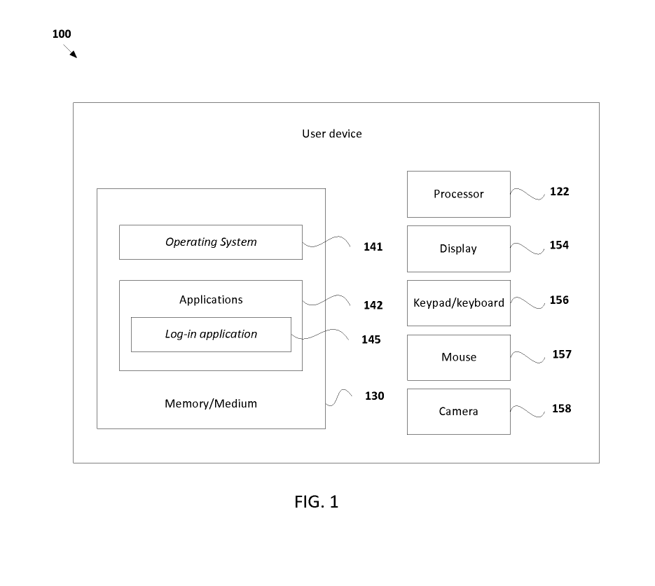

FIG. 1 is a schematic diagram illustrating an example of a user device which may execute the method of the present disclosure. As shown in FIG. 1, a user device 100 may be a computing device capable of executing a method and apparatus of present disclosure. The user device 100 may, for example, be a device such as a personal desktop computer or a portable device, such as a laptop computer, a tablet computer, a cellular telephone, or a smart phone.

The user device 100 may vary in terms of capabilities or features. Claimed subject matter is intended to cover a wide range of potential variations. For example, the user device 100 may include a keypad/keyboard 156 and a mouse 157. It may also include a display 154, such as a liquid crystal display (LCD), or a display with a high degree of functionality, such as a touch-sensitive color 2D or 3D display. The user device 100 may also include a camera 158.

The user device 100 may also include or may execute a variety of operating systems 141, including an operating system, such as a Windows™ or Linux™, or a mobile operating system, such as iOS™, Android™, or Windows Mobile™. The user device 100 may include or may execute a variety of possible applications 142, such as a log-in application 145 executable by a processor to implement the methods provided by the present disclosure.

Further, the user device 100 may include one or more non-transitory processor-readable storage media 130 and one or more processors 122 in communication with the non-transitory processor-readable storage media 130. For example, the non-transitory processor-readable storage media 130 may be a RAM memory, flash memory, ROM memory, EPROM memory, EEPROM memory, registers, hard disk, a removable disk, a CD-ROM, or any other form of non-transitory storage medium known in the art. The one or more non-transitory processor-readable storage media 130 may store sets of instructions, or units and/or modules that comprise the sets of instructions, for conducting operations described in the present application. The one or more processors may be configured to execute the sets of instructions and perform the operations in example embodiments of the present application.

In various examples of the present disclosure, in order to enable the user to log in the application using a gesture track, a relationship between the gesture track and account information of the user needs to be established in advance. The relationship may be stored in a gesture track database. Hereinafter, the establishment of the relationship between the gesture track and the account information of the user will be described in further detail.

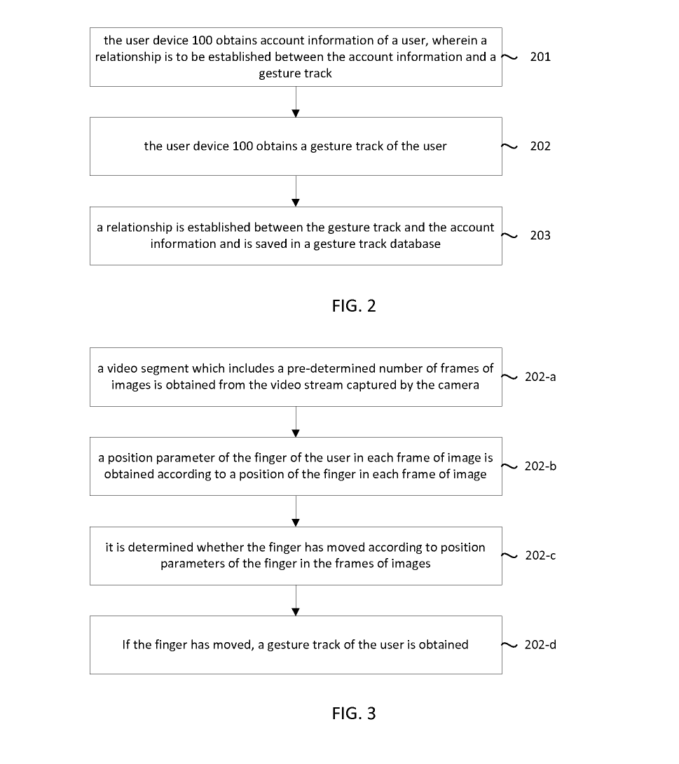

FIG. 2 is a schematic diagram illustrating a method for establishing a relationship between the gesture track and the account information according to an example of the present disclosure. FIG. 2 is a simplified diagram according to one embodiment of the present invention. This diagram is merely an example, which should not unduly limit the scope of the claims. One of ordinary skill in the art would recognize many variations, alternatives, and modifications.

As shown in FIG. 2, the method includes the following processes.

At block 201, the user device 100 obtains account information of a user, wherein a relationship is to be established between the account information and a gesture track.

In this block, the account information includes a user name and a password of the user. When the user desires to establish the relationship between the account information and a gesture track, the user inputs the account information first. In one example, the user may input the account information via the keypad/keyboard 156 or the mouse 157 of the user device 100.

At block 202, the user device 100 obtains a gesture track of the user.

In this block, after inputting the account information, the user inputs a gesture track to be stored in association with the account information. In the example as shown in FIG. 2, the user device 100 obtains the account information of the user first, and then obtains the gesture track of the user. It should be noted that, in a practical application, the user device 100 may also obtain the gesture track first, and then obtain the account information of the user.

For different types of user devices 100, there may be different methods to obtain the gesture track of the user.

For a portable user device 100 such as a smart phone, the gesture track may be obtained through capturing a slide movement of a user's finger on a touch screen of the portable user device 100.

For a fixed user device 100 such as a personal desktop computer, the gesture track may be obtained through capturing a handwriting track on a tablet or through capturing a drag/drop action of the mouse 157 or through capturing a hand movement via the camera 158 of the user device 100.

Hereinafter, the fixed user device is taken as an example user device 100 to describe the obtaining of the gesture track of the user. In particular, the following two methods for obtaining the gesture track of the user by the fixed user device are described: (1) the gesture track of the user is obtained according to a video stream captured by the camera 158 of the user device 100; (2) the gesture track of the user is obtained according to mouse messages of the operating system 141 of the user device 100.

It should be noted that, the present disclosure does not restrict the detailed method for obtaining the gesture track of the user. Based on the examples of the present disclosure, those ordinarily skilled in the art would obtain many variations without an inventive work.

FIG. 3 is a flowchart illustrating a first method for obtaining the gesture track of the user according to an example of the present disclosure. FIG. 3 is a simplified diagram according to one embodiment of the present invention. This diagram is merely an example, which should not unduly limit the scope of the claims. One of ordinary skill in the art would recognize many variations, alternatives, and modifications.

In the method as shown in FIG. 3, the gesture track of the user is obtained according to a video stream captured by the camera 158 of the fixed user device 100. In particular, the process of obtaining the gesture track of the user includes the following operations.

At block 202-a, a video segment which includes a pre-determined number of frames of images is obtained from the video stream captured by the camera 158 of the user device 100.

In this example, before the video segment is obtained, the video stream captured by the camera 158 may be converted into a pre-determined format. Then, the video segment including the pre-determined number of frames of images is obtained from the video stream in the pre-determined format. Thus, the gesture track of the user may be obtained according to positions of a finger of the user in the frames of images.

At block 202-b, a position parameter of the finger of the user in each frame of image is obtained according to a position of the finger in each frame of image.

In this block, each frame of image may be divided into multiple zones, wherein each zone includes equal number of pixels. An identifier is assigned to each zone. Thus, the identifier of the zone where the finger of the user is located may be taken as the position parameter of the finger in the frame of image. Those with ordinary skill in the art may also obtain the position parameter of the finger of the user via other manners. The present disclose does not restrict the detailed method for obtaining the position parameter.

In addition, if the finger of the user stretches over multiple zones, the position of a center point of the finger may be taken as a reference, i.e., the position parameter corresponding to the center point of the finger is taken as the position parameter of the finger in the frame of image.

At block 202-c, it is determined whether the finger has moved according to position parameters of the finger in all frames of images. If the finger has moved, block 202-d is performed. Otherwise, it is determined that the finger does not move. At this time, a message indicating that the gesture track of user is not obtained may be provided to user.

In this block, the process of determining whether the finger has moved may include: determining whether the position parameter of the finger in frame (i−1) is the same with that in frame i, wherein i is an integer smaller than the pre-determined number of frames. If they are different, it is determined that the finger has moved.

If the position parameters of the finger in all frames of images are the same, it is determined that the finger does not move. At this time, the method may return to block 202-a to obtain a new video segment.

At block 202-d, a gesture track of the user is obtained. The gesture track takes the position of the finger in the first frame as a start point, takes the position of the finger in the last frame as an end point, and takes positions of the finger is other frames (i.e., frames except for the first frame and the last frame) as intermediate points.

Now, through the above blocks 202-a to 202-d, the gesture track of the user is obtained. Hereinafter, the second method for obtaining the gesture track of the user will be described.

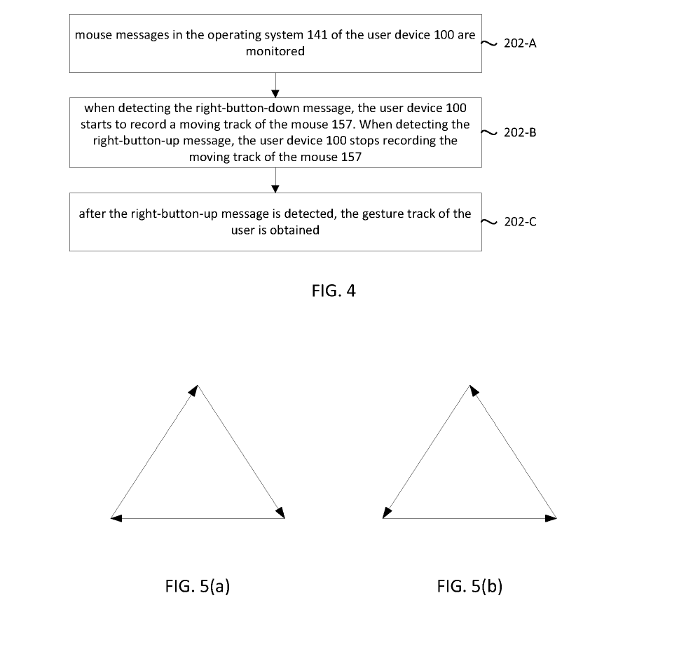

FIG. 4 is a flowchart illustrating a second method for obtaining a gesture track of the user according to an example of the present disclosure. FIG. 4 is a simplified diagram according to one embodiment of the present invention. This diagram is merely an example, which should not unduly limit the scope of the claims. One of ordinary skill in the art would recognize many variations, alternatives, and modifications.

In the method as shown in FIG. 4, the gesture track of the user is obtained according to mouse messages of the operating system 141 of the fixed user device 100. As shown in FIG. 4, the method includes the following operations.

At block 202-A, mouse messages in the operating system 141 of the user device 100 are monitored.

Generally, with respect to different operations of the user, mouse messages include a left-button-down message, a left-button-up message, a left-button-click message, a right-button-down message, a right-button-up message and a right-button-click message. Therefore, through monitoring the mouse messages in the operating system 141, the operation of the user's mouse 157 may be determined. For example, the user may press a right button of the mouse 157 and drag the mouse 157 to draw a triangle, and then release the right button of the mouse 157 to finish the drawing of the triangle.

In the above procedure, the pressing of the right button and the releasing of the right button respectively generates a right-button-down message and a right-button-up message. Therefore, through monitoring the right-button-down message and the right-button-up message, a moving track of the mouse (i.e., the gesture track of the user) may be obtained. Hereinafter, the right-button-down message and the right-button-up message are taken as an example to describe the obtaining of the gesture track according to the mouse messages in the operating system 141. It should be noted that, those ordinarily skilled in the art may use other mouse messages to obtain the gesture track of the user, which is not restricted in the present disclosure.

At block 202-B, when detecting the right-button-down message, the user device 100 starts to record a moving track of the mouse 157. When detecting the right-button-up message, the user device 100 stops recording the moving track of the mouse 157.

At block 202-C, after the right-button-up message is detected, the gesture track of the user is obtained, wherein the moving track of the mouse 157 recorded after the right-button-down message is detected and before the right-button-up message is detected is taken as the gesture track of the user.

Now, through the above blocks 202-A to 202-C, the gesture track of the user is obtained through monitoring the mouse messages of the user device 100.

It should be noted that, in various examples of the present disclosure, for a closed gesture track such as a circle or a triangle, the user may input the gesture track in a clockwise direction or in a counter clockwise direction. For example, as shown in FIG. 5(a) and FIG. 5(b) which are schematic diagrams illustrating gesture tracks of the user according to an example of the present disclosure. It can be seen that the gesture tracks in FIG. 5(a) and FIG. 5(b) are both triangles, i.e., they have the same shape. However, the gesture track in FIG. 5(a) is in a clockwise direction (as shown by the arrows), whereas the gesture track is FIG. 5(b) is in a counter clockwise direction (as shown by the arrows).

According to a practical requirement, it is possible to consider merely the shape of the gesture track but does not consider the direction of the gesture track. In other words, the gesture tracks as shown in FIG. 5(a) and FIG. 5(b) are regarded as the same gesture track since they have the same shape. Alternatively, it is also possible to consider both the shape and the direction of the gesture track. At this time, although two gesture tracks as shown in FIG. 5(a) and FIG. 5(b) have the same shape, they are regarded as different gesture tracks since they have different directions.

At block 203, a relationship is established between the gesture track and the account information and is saved in a gesture track database.

The relationship may be stored in the gesture track database as a table, i.e., the gesture track and the account information are stored in association in the gesture track database acting as table items of the table. In this block, in order to improve the security level of the account information of the user, the account information may be encrypted before being stored in the table.

It should be noted that, if the direction of the gesture track is taken into consideration, both shape information and direction information of the gesture track are stored in the gesture track database.

Through the above blocks 201-203, the relationship has been established between the account information and the gesture track. Thus, the user only needs to input the gesture track when desiring to log in the application or desiring to switch the account. In particular, the user may input the gesture track via the mouse 157 or the camera 158 of the user device 100 or through other manners. After the user device obtains the gesture track inputted by the user, the account information corresponding to the gesture track may be obtained according to the relationship saved in the gesture track database. Thus, the user is released from inputting the account information. Therefore, the operation of the user is simplified. In addition, since the input procedure of the account information is avoided, the account information has a lower risk to be stolen.

In addition, after the gesture track of the user is obtained in block 202, the method may further include a following process: determining whether the gesture track has been stored in the gesture track database. If the gesture track has been stored in the gesture track database, it indicates that the gesture track has been used, i.e., the gesture track has been stored in association with other account information. At this time, a message indicating that the gesture track has been used may be provided to the user. Then, the user may select another gesture track and block 202 is repeated to obtain the new gesture track of the user. If the gesture track is not stored in the gesture track database, it indicates that the gesture track has not been used. Thus, a relationship may be established between this gesture track and the account information of the user obtained in block 201.

In addition, if it is determined that the gesture track is not stored in the gesture track database, the user may be required to input the gesture track again to ensure the correctness of the gesture track. If the two gesture tracks are the same, the obtaining of the gesture track succeeds. Otherwise, a message indicating that the two gesture tracks are not consistent may be provided to the user. Then, the user may input the gesture track again.

Through the above blocks, the relationship between the gesture track and the account information is established and saved in the gesture track database. Thereafter, the user is able to log in the application using the gesture track.

Hereinafter, the method for logging in an application through a gesture track will be described in further detail.

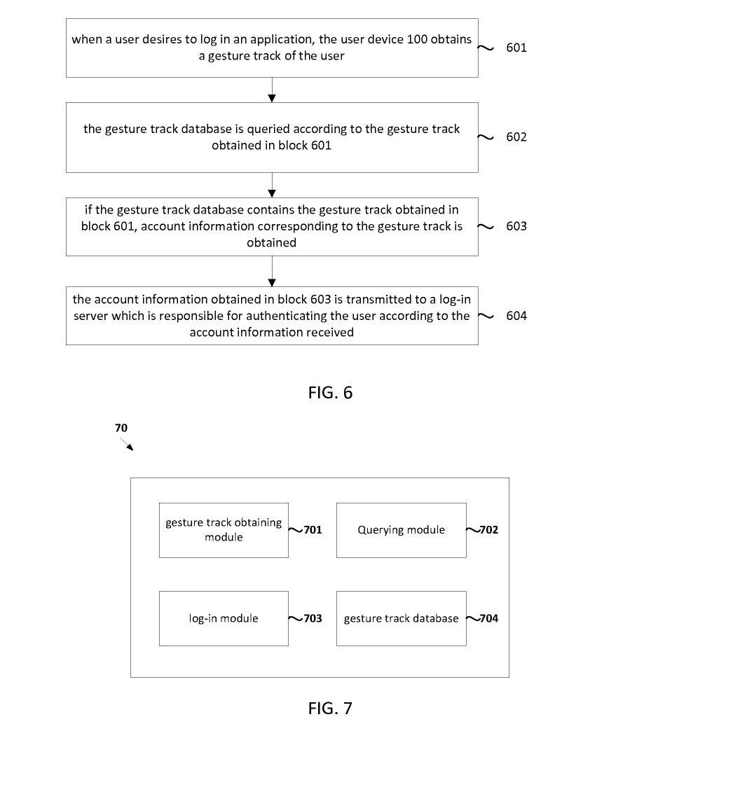

FIG. 6 is a flowchart illustrating a method for logging in an application according to an example of the present disclosure. FIG. 6 is a simplified diagram according to one embodiment of the present invention. This diagram is merely an example, which should not unduly limit the scope of the claims. One of ordinary skill in the art would recognize many variations, alternatives, and modifications.

As shown in FIG. 6, the method includes the following operations.

At block 601, when a user desires to log in an application, the user device 100 obtains a gesture track inputted by the user.

Similarly to block 202, the gesture track of the user may be obtained via various methods. Detailed operations of this block are similar to those in block 202 and will not be repeated herein.

At block 602, the gesture track database is queried according to the gesture track obtained in block 601.

At block 603, if the gesture track database contains the gesture track obtained in block 601, account information corresponding to the gesture track is obtained.

In particular, the gesture track of the user is taken as an index to search the gesture track database. If the account information corresponding to the gesture track is found, the account information is obtained.

As described above, the gesture track has two features: (1) shape; and (2) direction. Therefore, when the gesture track database is queried according to the gesture track of the user, there may be the following two situations.

In a first situation, only the shape information of the gesture track is stored in the gesture track database. At this time, if the gesture track of the user has the same shape with that stored in the gesture track database, it is determined that the gesture track database contains the gesture track of the user.

In a second situation, both the shape information and the direction information of the gesture track are stored in the gesture track database. At this time, if the gesture track of the user has both the same shape and the same direction with that in the gesture track database, it is determined that the gesture track database contains the gesture track of the user.

In addition, if what is stored in the gesture track database is encrypted account information, after the account information is obtained in this block, it is further required to decrypt the encrypted account information to obtain decrypted account information.

Furthermore, if the gesture track database does not contain the gesture track obtained in block 601, a message indicating that the gesture track inputted by the user is incorrect may be provided to the user. Then, the user may input the gesture track again and the method returns to block 601.

At block 604, the account information obtained in block 603 is transmitted to a log-in server which is responsible for authenticating the user according to the account information received. If the authentication succeeds, the user logs in the application successfully; otherwise, a message indicating that the log-in fails may be provided to the user.

According to the method provided by various examples of the present disclosure, the user is only required to input the gesture track when desiring to log in an application. Compared with conventional systems, the input procedure of the account information is avoided. Thus, the account information has a lower risk to be stolen and the user's operation is simplified.

In accordance with the above method, an example of the present disclosure further provides an apparatus for logging in an application. FIG. 7 is a schematic diagram illustrating an apparatus 70 for logging in an application according to an example of the present disclosure. FIG. 7 is a simplified diagram according to one embodiment of the present invention. This diagram is merely an example, which should not unduly limit the scope of the claims. One of ordinary skill in the art would recognize many variations, alternatives, and modifications.

As shown in FIG. 7, the apparatus 70 includes a gesture track obtaining module 701, a querying module 702, a log-in module 703 and a gesture track database 704.

The gesture track obtaining module 701 is configured to obtain a gesture track of a user.

The querying module 702 is configured to query the gesture track database 704 according to the gesture track obtained by the gesture track obtaining module 701, and to obtain account information corresponding to the gesture track if the gesture track database 704 contains the gesture track.

In particular, the querying module 702 takes the gesture track obtained by the gesture track obtaining module 701 as an index to query the gesture track database 704.

As described above, when the gesture track database 704 is queried according to the gesture track obtained by the gesture track obtaining module 701, there may be the following two situations.

In a first situation, only the shape information of the gesture track is stored in the gesture track database 704. At this time, if the gesture track obtained by the gesture track obtaining module 701 has the same shape with that stored in the gesture track database 704, it is determined that the gesture track database 704 contains the gesture track obtained by the gesture track obtaining module 701.

In a second situation, both the shape information and the direction information of the gesture track are stored in the gesture track database 704. At this time, if the gesture track obtained by the gesture track obtaining module 701 has both the same shape and the same direction with that in the gesture track database 704, it is determined that the gesture track database 704 contains the gesture track obtained by the gesture track obtaining module 701.

In addition, if what is stored in the gesture track database 704 is encrypted account information, after obtaining the account information, querying module 702 is further configured to decrypt the encrypted account information to obtain decrypted account information.

Furthermore, if the gesture track database 704 does not contain the gesture track obtained by the gesture track obtaining module 701, the querying module is further configured to provide a message indicating that the gesture track inputted by the user is incorrect to the user.

The log-in module 703 is configured to transmit the account information obtained by the querying module 702 to a log-in server which is responsible for authenticating the user according to the account information, wherein if the authentication succeeds, the user logs in the application successfully.

The gesture track database 704 is configured to save a relationship between the gesture track and the account information.

In particular, the gesture track obtaining module 701 may obtain the gesture track according to a video stream captured by a camera of the apparatus 70, or may obtain the gesture track according to mouse messages of an operating system of the apparatus 70, or through other manners. It should be noted that the gesture track obtaining module 701 may also obtain the gesture track via various manners, which is not restricted in the present disclosure.

According to the apparatus 70 provided by various examples of the present disclosure, the user is only required to input the gesture track when desiring to log in an application. Compared with conventional systems, the input procedure of the account information is avoided. Thus, the account information has a lower risk to be stolen and the user's operation is simplified.

The above modules may be implemented by software (e.g. machine readable instructions stored in the memory 130 and executable by the processor 122 as shown in FIG. 1), hardware, or a combination thereof.

In addition, the above modules may be disposed in one or more apparatuses. The above modules may be combined into one module or divided into multiple sub-modules.

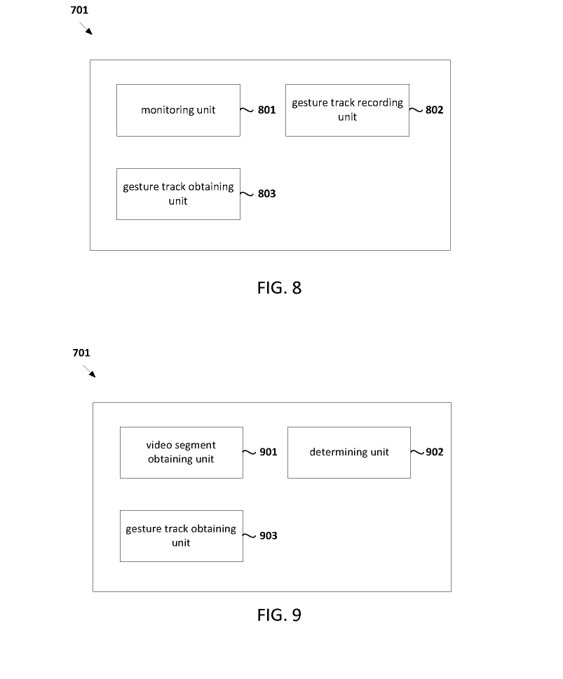

FIG. 8 is a schematic diagram illustrating a structure of the gesture track obtaining module 701 according to an example of the present disclosure. FIG. 8 is a simplified diagram according to one embodiment of the present invention. This diagram is merely an example, which should not unduly limit the scope of the claims. One of ordinary skill in the art would recognize many variations, alternatives, and modifications.

As shown in FIG. 8, the gesture track obtaining module 701 includes:

a monitoring unit 801, configured to monitor mouse messages of an operating system of the apparatus 70;

a gesture track recording unit 802, configured to start to record a moving track of a mouse of the apparatus 70 when a right-button-down message is detected, to stop recording the moving track of the mouse when a right-button-up message is detected; and

a gesture track obtaining unit 803, configured to take the moving track recorded after the right-button-down message is detected and before the right-button-up message is detected as the gesture track of the user.

FIG. 9 is a schematic diagram illustrating a structure of the gesture track obtaining module 701 according to another example of the present disclosure. FIG. 9 is a simplified diagram according to one embodiment of the present invention. This diagram is merely an example, which should not unduly limit the scope of the claims. One of ordinary skill in the art would recognize many variations, alternatives, and modifications.

As shown in FIG. 9, the gesture track obtaining module 701 includes:

a video segment obtaining unit 901, configured to obtain a video segment including a pre-determined number of frames of images from a video stream captured by a camera of the apparatus 70;

a determining unit 902, configured to determine whether a finger of the user moves according to position parameters of the finger in the frames of images; and

a gesture track obtaining unit 903, configured to obtain the gesture track of the user if the determining unit 902 determines that the finger of the user moves, wherein the gesture track takes a position of the finger in a first frame as a start point, takes a position of the finger in a last frame as an end point, and takes positions of the finger in other frames as intermediate points.

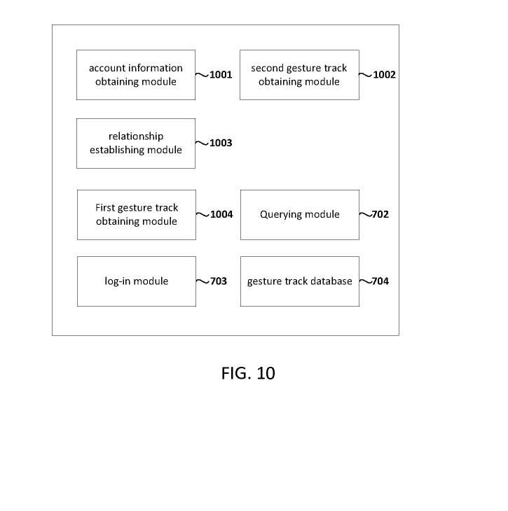

FIG. 10 is a schematic diagram illustrating a structure of an apparatus according to an example of the present disclosure. As shown in FIG. 10, the apparatus includes: an account information obtaining module 1001, a second gesture track obtaining module 1002, a relationship establishing module 1003, a first gesture track obtaining module 1004, a querying module 702, a log-in module 703 and a gesture track database 704.

The functions of the first gesture track obtaining module 1004 are similar to those of the gesture track obtaining module 701 shown in FIG. 7. The querying module 702, the log-in module 703 and the gesture track database 704 in FIG. 10 are respectively the same with corresponding modules shown in FIG. 7. Therefore, the functions of these modules are not repeated herein.

The account information obtaining module 1001 is configured to obtain account information inputted by the user and provide the account information to the relationship establishing module 1003, wherein the account information includes a user name and a password of the user for logging in the application.

The second gesture track obtaining module 1002 is configured to obtain a gesture track inputted by the user and provide the gesture track obtained to the relationship establishing module 1003. Detailed functions for obtaining the gesture track of the user may be seen from the above method examples and will not be repeated herein.

The relationship establishing module 1003 is configured to establish a relationship between the account information obtained by the account information obtaining module 1001 and the gesture track obtained by the second gesture track obtaining module 1002, and is configured to provide the relationship to the gesture track database 704 for storage. In particular, the account information obtained by the account information obtaining module 1001 and the gesture track obtained by the second gesture track obtaining module 1002 may be saved in association with each other in the gesture track database 704.

As described above, when providing the relationship to the gesture track database 704 for storage, the relationship establishing module 1003 may provide only the shape information of the gesture track obtained by the second gesture track obtaining module 1002 to the gesture track database 704. Alternatively, the relationship establishing module 1003 may also provide both the shape information and the direction information of the gesture track obtained by the second gesture track obtaining module 1002 to the gesture track database 704.

In addition, in order to improve the security level of the account information, the account information may be encrypted before being stored in the gesture track database.

In one example, after obtaining the gesture track of the user, the second gesture track obtaining module 1002 is further configured to determine whether the gesture track is stored in the gesture track database 704, provide a message indicating that the gesture track has been used to the user if the gesture track is stored in the gesture track database 704, and provide the gesture track obtained to the relationship establishing module 1003 if otherwise.

In addition, after determining that the gesture track is not stored in the gesture track database 704, the second gesture track obtaining module 1002 is further configured to obtain the gesture track for a second time, compare whether two gesture tracks inputted by the user are consistent, provide the gesture track to the relationship establishing module 1003 if the two gesture tracks are consistent, and provide a message indicating that the two gesture tracks are inconsistent to the user if otherwise.

What has been described and illustrated herein is a preferred example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. A computer-implemented method for logging in an application, comprising:
obtaining, by a user device, a gesture track of a user;
querying, by the user device, a gesture track database according to the gesture track obtained, wherein the gesture track database stores a relationship between the gesture track and account information of the user;
obtaining, by the user device, the account information corresponding to the gesture track; and
providing, by the user device, the account information to a log-in server, so as to log in the application;
the method further comprising:
before obtaining the gesture track of the user, establishing the relationship between the gesture track and the account information, and proving the relationship to the gesture track database for storage;
wherein the establishing the relationship between the gesture track and the account information, and providing the relationship to the gesture track database for storage comprises:
receiving, by the user device, the account information inputted by the user; and
obtaining, by the user device, the gesture track inputted by the user; and
providing, by the user device, the account information and the gesture track to the gesture track database for storage, wherein the account information and the gesture track are stored in association with each other in the gesture track database;
before providing the account information and the gesture track to the gesture track database, the method further comprising:
determining, by the user device, whether the gesture track database contains the gesture track inputted by the user;
if the gesture track database does not contain the gesture track inputted by the user, performing the process of providing the account information and the gesture track to the gesture track database.

2. The computer-implemented method of claim 1, wherein the obtaining the gesture track of the user comprises:
capturing a video stream via a camera of the user device, and obtaining the gesture track of the user according to the video stream captured; or
monitoring mouse messages of an operating system of the user device, and obtaining the gesture track of the user according to the mouse messages.

3. The computer-implemented method of claim 2, wherein the obtaining the gesture track of the user according to the video stream captured comprises:
obtaining, by the user device, a pre-determined number of frames of images from the video stream captured by the camera of the user device;
determining, by the user device, position parameters of a finger of the user in each frame of image according to positions of the finger in each frame of image;
determining, by the user device, whether the finger moves according to the position parameters of the finger in all frames of images; and
obtaining, by the user device, the gesture track if it is determined that the finger moves, wherein a position of the finger in a first frame of image is taken as a start point of the gesture track, a position of the finger in a last frame of image is taken as an end point of the gesture track, and positions of the finger in other frames of images are taken as intermediate points of the gesture track.

4. The computer-implemented method of claim 2, wherein the obtaining the gesture track of the user according to the mouse messages comprises:
monitoring, by the user device, mouse messages of the operating system of the user device;
if a right-button-down message is detected, starting to record a moving track of a mouse of the user device;
if a right-button-up message is detected, stopping recording the moving track of the mouse of the user device; and
obtaining, by the user device, the gesture track of the user, wherein the moving track of the mouse of the user device recorded after the right-button-down message is detected and before the right-button-up message is detected is taken as the gesture track of the user.

5. The computer-implemented method of claim 1, further comprising:
if the gesture track database contains the gesture track inputted by the user, providing, by the user device, a message indicating that the gesture track has been used to the user.

6. The computer-implemented method of claim 1, wherein both shape information and direction information of the gesture track are saved in the gesture track database, or only shape information of the gesture track is saved in the gesture track database.

7. An apparatus for logging in an application, comprising:
one or more processors;
memory; and
one or more program modules stored in the memory and to be executed by the one or more processors, the one or more program modules including:
a first gesture track obtaining module, configured to obtain a gesture track of a user;
a querying module, configured to query a gesture track database according to the gesture track obtained by the gesture track obtaining module, and to obtain account information corresponding to the gesture track if the gesture track database contains the gesture track;
a log-in module, configured to provide the account information obtained by the querying module to a log-in server, so as to log in the application; and
the gesture track database, configured to save a relationship between the gesture track and the account information;
the apparatus further comprising: an account obtaining module, a second gesture track obtaining module and a relationship establishing module; wherein
the account obtaining module is configured to obtain the account information inputted by the user and provide the account information to the relationship establishing module;
the second gesture track obtaining module is configured to obtain the gesture track inputted by the user and provide the gesture track obtained to the relationship establishing module; and
the relationship establishing module is configured to establish a relationship between the account information obtained by the account information obtaining module and the gesture track obtained by the second gesture track obtaining module, and provide the relationship to the gesture track database for storage.

8. The apparatus of claim 7, wherein the first gesture track obtaining module further comprises:
a monitoring unit, configured to monitor mouse messages of an operating system of the apparatus;
a gesture track recording unit, configured to start to record a moving track of a mouse when a right-button-down message is detected, to stop recording the moving track of the mouse when a right-button-up message is detected; and
a gesture track obtaining unit, configured to take the moving track recorded after the right-button-down message is detected and before the right-button-up message is detected as the gesture track of the user.

9. The apparatus of claim 7, wherein the first gesture track obtaining module further comprises:
a video segment obtaining unit, configured to obtain a video segment including a pre-determined number of frames of images from a video stream captured by a camera of the apparatus;
a determining unit, configured to determine whether a finger of the user moves according to position parameters of the finger in the frames of images; and
a gesture track obtaining unit, configured to obtain the gesture track of the user if the determining unit determines that the finger of the user moves, wherein the gesture track takes a position of the finger in a first frame as a start point, takes a position of the finger in a last frame as an end point, and takes positions of the finger in other frames as intermediate points.

10. The apparatus of claim 7, wherein the relationship establishing module is further configured to provide shape information of the gesture track obtained by the second gesture track obtaining module to the gesture track database; or provide both shape information and direction information of the gesture track obtained by the second gesture track obtaining module to the gesture track database.

11. The apparatus of claim 7, wherein the second gesture track obtaining module is further configured to determine, after obtaining the gesture track of the user, whether the gesture track database contains the gesture track obtained by the second gesture track obtaining module, provide a message indicating that the gesture track has been used to the user if the gesture track database contains the gesture track obtained by the second gesture track obtaining module, and provide the gesture track obtained by the second gesture track obtaining module to the relationship establishing module if otherwise.

12. The apparatus of claim 11, wherein the second gesture track obtaining module is further configured to receive, after determining that the gesture track database does not contain the gesture track obtained by the second gesture track obtaining module, the gesture track for a second time, compare whether two gesture tracks inputted by the user are consistent, provide the gesture track to the relationship establishing module if the two gesture tracks are consistent, and provide a message indicating that the two gesture tracks are inconsistent to the user if otherwise.

13. A non-transitory computer-readable storage medium comprising a set of instructions for logging in an application, the set of instructions to direct at least one processor to perform acts of:
obtaining a gesture track of a user;
querying a gesture track database according to the gesture track obtained, wherein the gesture track database stores a relationship between the gesture track and account information of the user;
obtaining the account information corresponding to the gesture track; and
providing the account information to a log-in server, so as to log in the application;
wherein before obtaining the gesture track of the user,
receiving the account information inputted by the user; and
obtaining the gesture track inputted by the user; and
providing the account information and the gesture track to the gesture track database for storage;
wherein before providing the account information and the gesture track to the gesture track database, determining whether the gesture track database contains the gesture track inputted by the user;
if the gesture track database does not contain the gesture track inputted by the user, performing the process of providing the account information and the gesture track to the gesture track database.

14. The non-transitory computer-readable storage medium of claim 13, wherein the process of obtaining the gesture track of the user comprises:
capturing a video stream via a camera and obtaining the gesture track of the user according to the video stream captured; or
monitoring mouse messages of an operating system and obtaining the gesture track of the user according to the mouse messages.
